(19) United States
(12) Patent Application Publication
(10) Pub. No.: US 2014/0084724 A1
(43) Pub. Date: Mar. 27, 2014

(54) HYDRODYNAMIC BEARING ASSEMBLY AND SPINDLE MOTOR INCLUDING THE SAME

(71) Applicant: SAMSUNG ELECTRO-MECHANICS CO., LTD., Suwon (KR)

(72) Inventor: Sang Sun KANG, Suwon (KR)

(73) Assignee: SAMSUNG ELECTRO-MECHANICS CO., LTD., Suwon (KR)

(21) Appl. No.: 13/764,052

(22) Filed: Feb. 11, 2013

(30) Foreign Application Priority Data
Sep. 24, 2012 (KR) 10-2012-0105770
Nov. 30, 2012 (KR) 10-2012-0138485

(51) Int. Cl. F16C 32/06; H02K 7/08

(52) U.S. Cl. CPC F16C 32/06; H02K 7/08
USPC 310/90; 384/100; 384/112

(57) ABSTRACT

There are provided a hydrodynamic bearing assembly and a spindle motor including the same, the hydrodynamic bearing assembly including a sleeve having a shaft inserted therein, a rotor coupled to an upper portion of the shaft in an axial direction to rotate together with the shaft, and a stopper plate including a horizontal portion coupled to an upper surface of the sleeve in the axial direction and a vertical portion extending downwardly in the axial direction from an outer surface of the horizontal portion to be fixed to an outer surface of the sleeve in an outer diameter direction, and preventing the shaft from floating at a time of rotation of the shaft.

### CROSS-REFERENCE TO RELATED APPLICATIONS

This application claims the priorities of Korean Patent Application Nos. 10-2012-0105770 filed on Sep. 24, 2012 and 10-2012-0138485 filed on Nov. 30, 2012, in the Korean Intellectual Property Office, the disclosure of which is incorporated herein by reference.

### BACKGROUND OF THE INVENTION

1. Field of the Invention

The present invention relates to a hydrodynamic bearing assembly and a spindle motor including the same.

2. Description of the Related Art

A small spindle motor used in a recording disk driving apparatus may include a fixed member, a rotating member coupled to the fixed member to rotate based on a rotating shaft, a stopping member preventing a separation of the rotating member, and a lubricating fluid interposed between the rotating member and the fixed member, and the rotation of the rotating member is supported by fluid pressure generated in the lubricating fluid.

The stopping member is fixed to the rotating member, and the stopping member may be classified as a flange-shaped stopping member coupled to a shaft, a ring-shaped stopping member coupled to a rotor case, and the like.

However, it is difficult to manufacture the flange-shaped stopping member integrated with the shaft. In the case in which the flange-shaped stopping member is separately manufactured and is then assembled with the shaft, high level of process qualities, such as sealing management, coaxiality management, and the like may be required.

Further, since the lubricating fluid is not interposed between the stopping member and the fixed member, the ring-shaped stopping member exhibits solid friction behavior, such that friction and abrasion loss between the members may be increased to cause particles to be introduced into a bearing.

In order to solve the above defects, the present applicant filed Korean Patent Laid-Open No. 10-2012-0006717 and the application was registered (hereinafter, referred to as ‘Registered Patent’). However, the Registered Patent has a disadvantage in which a coupling strength of a stopper plate coupled to an axial upper surface of a sleeve may be low.

### RELATED ART DOCUMENT

(Patent Document 1) Korean Patent Laid-Open Publication No. 10-2012-0006717

### SUMMARY OF THE INVENTION

An aspect of the present invention provides a stopper plate to prevent a rotor and a shaft from overfloating and allow a thrust dynamic pressure bearing to be provided in an optically efficient position.

Another aspect of the present invention improves a coupling strength of a stopper plate coupled to a sleeve to enable the stopper plate to appropriately perform a function of a stopper.

According to an aspect of the present invention, there is provided a hydrodynamic bearing assembly, including: a sleeve having a shaft inserted therein; a rotor coupled to an upper portion of the shaft in an axial direction to rotate together with the shaft; and a stopper plate including a horizontal portion coupled to an upper surface of the sleeve in the axial direction and a vertical portion extending downwardly in the axial direction from an outer surface of the horizontal portion to be fixed to an outer surface of the sleeve in an outer diameter direction, and preventing the shaft from floating at a time of rotation of the shaft.

At least one of an upper surface of the stopper plate and a lower surface of the rotor corresponding to the upper surface of the stopper plate may be provided with a dynamic pressure generation groove.

The dynamic pressure generation groove may be formed in at least one of the upper surface of the stopper plate in the outer diameter direction and the lower surface of the rotor corresponding thereto.

A clearance may be formed between an inner circumferential surface of the stopper plate and an outer circumferential surface of the shaft corresponding to the inner circumferential surface of the stopper plate.

An inner diameter of the stopper plate may be smaller than that of the sleeve.

The shaft may be provided with a stepped jaw portion caught by a lower inner surface of the stopper plate.

The rotor may be provided with a cylindrical wall portion extending downwardly in the axial direction, and a liquid-vapor interface of a lubricating fluid may be formed between an inner surface of the cylindrical wall portion and an outer surface of the vertical portion.

The sleeve may be provided with a bypass channel communicating with the upper surface and a lower surface of the sleeve in the axial direction, and a communicating portion allowing the bypass channel to communicate with an inner surface of the sleeve in an inner diameter direction may be disposed between the sleeve and the stopper plate.

The communicating portion may be a first communicating groove disposed in the upper surface of the sleeve in the axial direction and allowing the bypass channel to communicate with the inner surface of the sleeve in the inner diameter direction.

The communicating portion may be a second communicating groove disposed in a lower surface of the stopper plate in the axial direction and allowing the bypass channel to communicate with the inner surface of the sleeve in the inner diameter direction.

The communicating portion may be a step spacing portion disposed on the upper surface of the sleeve in the axial direction and stepped downwardly in the axial direction from the bypass channel to an inner portion of the sleeve.

At least one of an upper surface of the stopper plate and a lower surface of the rotor corresponding to the upper surface of the stopper plate may be provided with a dynamic pressure generation groove.

The stopper plate may be provided to entirely cover the upper surface of the sleeve.

The vertical portion may be continuously provided in a circumferential direction.

The vertical portion may be press-fitted and coupled to the outer surface of the sleeve in the outer diameter direction.

The vertical portion may be bonded to the outer surface of the sleeve in the outer diameter direction by an adhesive.

The stopper plate may be manufactured by a sintering method.

According to another aspect of the present invention, there is provided a spindle motor, including: a rotor including a hub having a hollow formed therein and having a shaft inserted therein and a magnet support portion extending in an outer diameter direction from the hub and bent downwardly in an axial direction to support a magnet; a bearing member including a sleeve supporting a rotation of the shaft and a stopper plate including a horizontal portion coupled to an upper surface of the sleeve in the axial direction and a vertical portion extending downwardly in the axial direction from an outer surface of the horizontal portion to be fixed to an outer surface of the sleeve in the outer diameter direction and preventing the shaft from floating at a time of the rotation of the shaft; and a stator including a core disposed outside of the sleeve and having a winding coil wound therearound to generate a rotational driving force by electromagnetic interaction with the magnet.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a hydrodynamic bearing assembly and a spindle motor including the same according to an embodiment of the present invention;

FIG. 2 is an enlarged view of portion A of FIG. 1;

FIG. 3 is a cutaway perspective view of the hydrodynamic bearing assembly according to the embodiment of the present invention;

FIGS. 4A and 4B are cutaway perspective views of a stopper plate according to the embodiment of the present invention;

FIGS. 5A and 5B are cutaway perspective views of a sleeve according to the embodiment of the present invention;

FIG. 6 is a pattern diagram of a herringbone groove of a thrust dynamic pressure bearing according to an embodiment of the present invention;

FIG. 7 is a pattern diagram of a spiral groove of a thrust dynamic pressure bearing according to an embodiment of the present invention; and

FIG. 8 is a cross-sectional view illustrating a hard disk drive according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

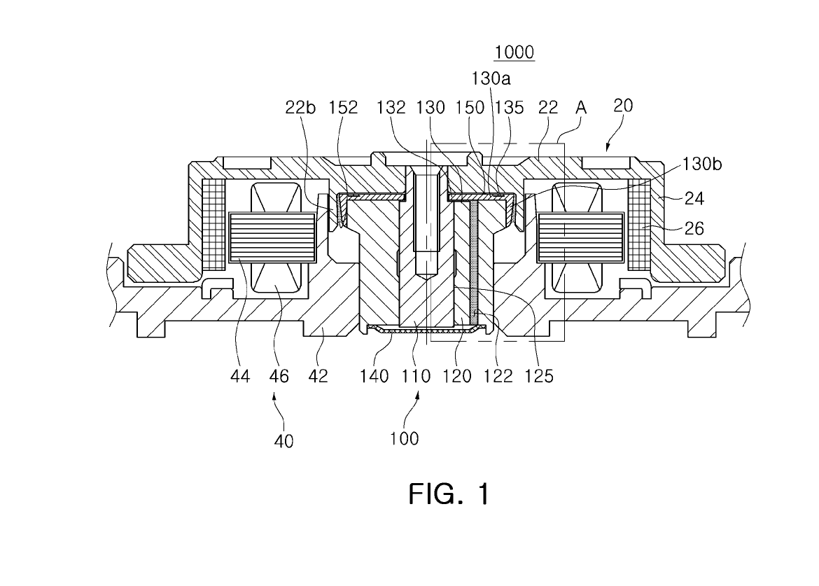

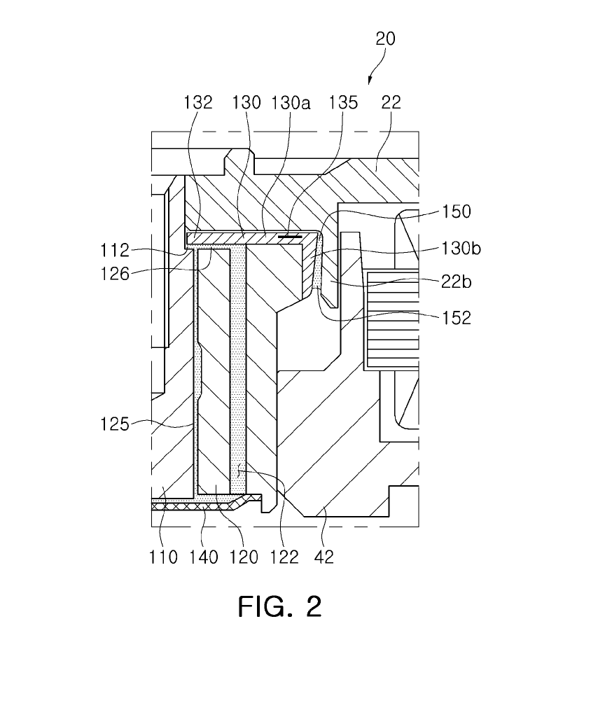

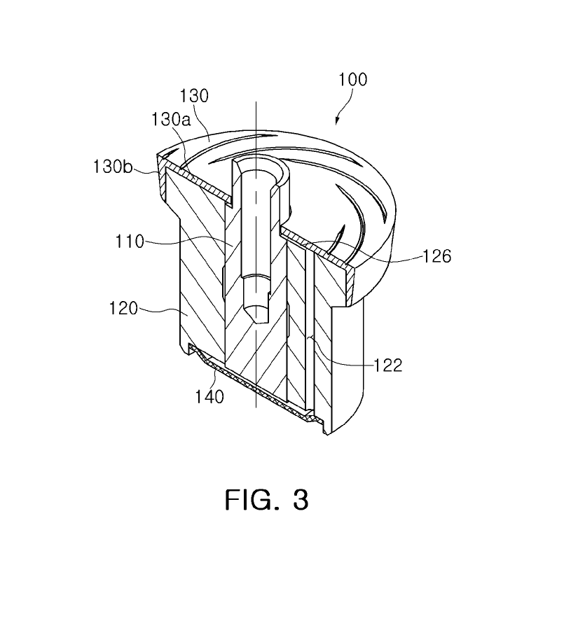

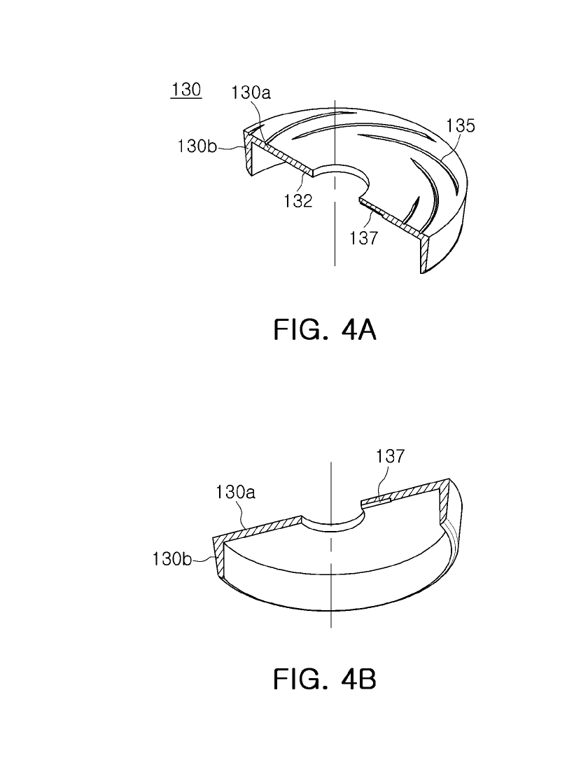

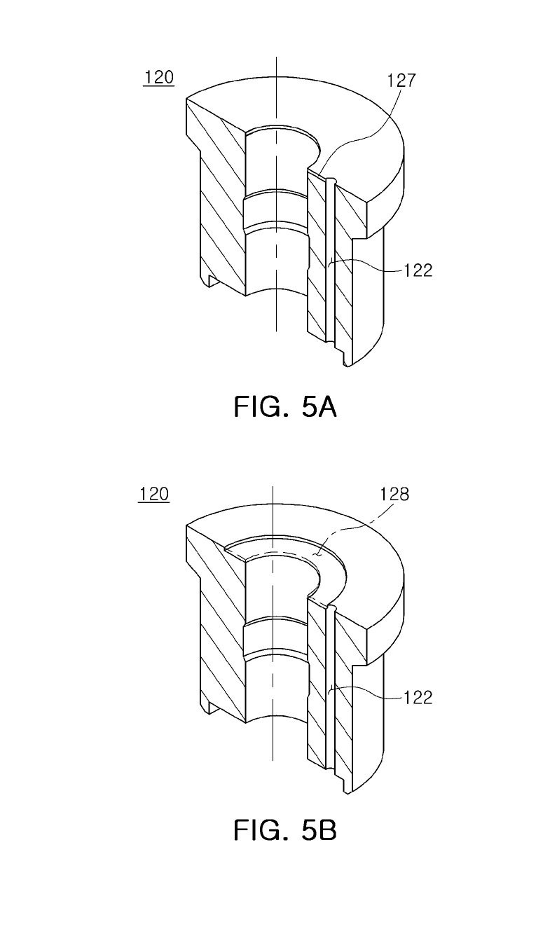

FIG. 1 is a schematic cross-sectional view illustrating a hydrodynamic bearing assembly and a spindle motor including the same according to an embodiment of the present invention; FIG. 2 is an enlarged view of portion A of FIG. 1; FIG. 3 is a cutaway perspective view of the hydrodynamic bearing assembly according to the embodiment of the present invention; FIGS. 4A and 4B are cutaway perspective views of a stopper plate according to the embodiment of the present invention; and FIGS. 5A and 5B are cutaway perspective views of a sleeve according to the embodiment of the present invention.

Referring to FIGS. 1 to 2, a spindle motor 1000 according to an embodiment of the present invention may include a hydrodynamic bearing assembly 100, a rotor 20, and a stator 40.

The detailed embodiments of the hydrodynamic bearing assembly will be described below. The spindle motor 1000 according to the embodiment of the present invention may have all the detailed features of respective embodiments of the hydrodynamic bearing assembly 100.

The rotor 20 is a rotating structure rotatably provided with respect to the stator 400 and may include a rotor case having a magnet 26 on an inner circumferential surface thereof, the magnet having an annular ring shape and corresponding to a core 44 with a predetermined distance.

Further, the magnet 26 is provided as a permanent magnet of which an N pole and an S pole are alternately magnetized in a circumferential direction to generate magnetic force having predetermined strength. The rotor 20 rotates by electromagnetic interaction between a coil 46 and the magnet 24.

Here, the rotor case includes a hub 22 fixed to an upper end of a shaft 110 and a magnet support portion 24 extending in an outer diameter direction from the hub 22 and bent downwardly in an axial direction to support the magnet 26 of the rotor 20.

The hub 22 may include a disk portion 22a having a hollow portion into which the shaft 110 is inserted and a cylindrical wall portion 22b protruded downwardly in the axial direction from the disk portion 22a and forming a meniscus of a lubricating fluid to seal oil between an outer surface of a vertical portion 130b in the outer diameter direction and the cylindrical wall portion 22b to thereby form a liquid-vapor interface. In this case, the cylindrical wall portion 22b has an inner circumferential surface inclined to allow for taper-sealing of the oil.

Meanwhile, defining terms for directions, as illustrated in FIG. 1, an axial direction may refer to a vertical direction based on a shaft 110, and an inner diameter or outer diameter direction may refer to a direction toward an outside end of a rotor 20 based on the shaft 110 or a direction toward a center of the shaft 110 based on the outside end of the rotor 20. Further, a circumferential direction may refer to a direction of rotation at a predetermined radius based on a rotating shaft.

The stator 40 is a fixed structure including the coil 46, that is, a winding coil generating a predetermined magnitude of electromagnetic force when power is applied thereto and the core 44 around which the winding coil 46 is wound.

The core 44 is fixed to an upper portion of a base 42 provided with a printed circuit board (not illustrated) on which pattern circuits are printed, a plurality of coil holes having a predetermined diameter may penetrate through an upper surface of the base 42 corresponding to the winding coil 46 so as to expose the winding coil 46 downwardly, and the winding coil 46 is electrically connected with the printed circuit board such that external power is applied thereto.

The hydrodynamic bearing assembly 100 may include the shaft 110, a sleeve 120, a stopper plate 130, the hub 22, and a cover plate 140. The hub 20 may be a component constituting the hydrodynamic bearing assembly 100 while constituting the rotor 20.

Referring to FIGS. 3 to 5, the shaft 110 is inserted into the hollow portion formed in a central portion of the sleeve 120, the stopper plate 130 is disposed on an upper portion of the sleeve 120 in the axial direction, and the cover plate 140 is disposed downwardly of the shaft 110 and the sleeve 120.

Here, the shaft 110 is inserted into the hollow portion of the sleeve 120 so as to have a micro clearance therewith. The micro clearance 125 is filled with oil (lubricating fluid) and the rotation of the shaft 110 and the rotor 20 fixed to the upper end of the shaft 110 may be smoothly supported by dynamic pressure generated due to a radial bearing formed on at least one of an outer diameter portion of the shaft 110 and an inner diameter portion of the sleeve 120.

In this case, one of an outer circumferential surface of the shaft 110 and an inner circumferential surface of the sleeve 120 may be provided with a spiral or a herringbone groove, and the radial bearing is formed by the oil filling the groove and the micro clearance such that the rotation of the shaft 110 may be smoothly supported.

Further, the shaft 110 may be provided with a stepped jaw portion 112 caught by a lower inner surface of a horizontal portion 130a constituting the stopper plate 130. The stepped jaw portion 112 may be formed in a stepped manner vertically in the axial direction. The stepped jaw portion 112 is caught by an inner surface of the stopper plate 130, thereby serving as a stopper preventing the shaft 110 and the rotor 20 from overfloating.

The cover plate 140 may cover a lower portion of the sleeve 120 to support the sleeve 120 and the shaft 110. An outer circumferential surface of the cover plate 140 may come into contact with the inner circumferential surface of the sleeve 120 to thereby be coupled thereto and a bending portion of the cover plate 140 formed by bending the outer circumferential surface of the cover plate 140 in axial direction may be coupled to the inner circumferential surface of the sleeve 120. A clearance between the cover plate 140 and the sleeve 120 is filled with oil, to thereby serving as a bearing supporting a lower surface of the shaft 110.

The sleeve 120 may have the hollow portion in the central portion thereof into which the shaft 110 is inserted. Further, an outer circumferential surface of the sleeve 120 is coupled to the base 42 of the stator 40 at a lower portion thereof. Further, the outer circumferential surface of the sleeve 120 may face the cylindrical wall portion 22b of the hub 22 at an upper portion thereof. In this case, a liquid-vapor interface (meniscus) 152 of the lubricating fluid (oil) may be disposed between the upper portion of the outer circumferential surface of the sleeve 120 and the cylindrical wall portion 22b.

The inner circumferential surface of the sleeve 120 may be provided with a spiral or herringbone groove so as to generate dynamic fluid pressure between the sleeve 120 and the shaft 110.

Further, a bypass channel 122 communicating between upper and lower portions of the sleeve 120 and dispersing pressure in the oil (lubricating fluid) may be provided. In this configuration, a communicating portion 126 allowing the bypass channel 122 to communicate with an inner surface of the sleeve 120 in the inner diameter direction may be disposed between the sleeve 120 and the stopper plate 130 disposed on the upper portion of the sleeve 120.

The communicating portion 126 may be a first communicating groove 127 disposed in an upper surface of the sleeve 120 in the axial direction and allowing the bypass channel 122 to communicate with the inner surface of the sleeve 120 in the inner diameter direction.

Further, the communicating portion 126 may be a step spacing portion 128 disposed on the upper surface of the sleeve 120 and stepped downwardly in the axial direction from the bypass channel 122 to an inner portion of the sleeve 120. The step spacing portion 128 may be disposed on all or a portion of the upper surface of the sleeve 120 in a circumferential direction.

Further, although described below, the communicating portion 126 may be a second communicating groove 137 formed in a lower surface of the stopper plate 130 in the axial direction and allowing the bypass channel 122 to communicate with the inner surface of the sleeve 120 in the inner diameter direction.

The sleeve 120 may be formed by forging copper (Cu) or aluminum (Al) or sintering Cu—Fe-based alloy powder or SUS-based powder.

The stopper plate 130 may be fixed and coupled to the upper portion of the sleeve 120 in the axial direction. The stopper plate 130 has the vertical portion 130b formed on an outer surface thereof in the outer diameter direction and extending downwardly in the axial direction, such that the stopper plate 130 may be fixed to an outer surface of the sleeve 120 in the outer diameter direction. Further, the entire upper surface of the sleeve 120 may be fixed to the lower surface of the stopper plate 130. That is, the surface of the sleeve 120 may be coupled to the surface of the stopper plate 130 by adhesive bonding, welding, and the like.

The stopper plate 130 may include the horizontal portion 130a coupled to the upper surface of the sleeve 120 and the vertical portion 130b extending downwardly in the axial direction from the outer surface of the horizontal portion 130a to thereby be fixed to the outer surface of the sleeve 120 in the outer diameter direction.

The vertical portion 130b may be continuously provided in the circumferential direction. Here, the vertical portion 130b may be fitted into the outer surface of the sleeve 120 in the outer diameter direction by a coupling method such as a press-fitting method, a sliding method, and the like. Further, bonding coupling using an adhesive, welding coupling, and the like, as well as the press-fitting method may be performed.

A micro clearance is formed between an inner circumferential surface of the stopper plate 130, more specifically, an inner surface of the horizontal portion 130a in the inner diameter direction and an outer surface of the shaft 110 in the outer diameter direction, and may be filled with the oil as the lubricating fluid 150.

In addition, the stopper plate 130 may be manufactured by a sintering method. The liquid-vapor interface may be disposed between the vertical portion 130b of the stopper plate 130 and an inner surface of the cylindrical wall portion 22b in the inner diameter direction. As a result, the stopper plate 130 may be manufactured by a sintering method to efficiently prevent a fluid from being leaked.

The stopper plate 130 may include a protruded portion 132 protruded to be disposed more inwardly than the inner surface of the sleeve 120 in the inner diameter direction to thereby caught by the stepped jaw portion 112 disposed on the outer circumferential surface of the shaft 110 at the time of the rotation of the shaft 110. That is, the stopper plate 130, in more detail, an inner diameter of the vertical portion 130b may be smaller than that of the sleeve 120.

When the shaft 110 floats due to pressure in the oil (lubricating fluid) at the time of the rotation thereof, the stepped jaw portion 112 of the shaft 110 is caught by the protruded portion 132 of the stopper plate 130 to prevent the shaft 110 from overfloating.

The stopper plate 130 may have a thrust dynamic pressure generation groove 135 formed therein, and the oil as the lubricating fluid 150 may be filled between the disk portion 22a of the hub 22 and the stopper plate 130, in more detail, the upper surface of the vertical portion 130a in the axial direction to form a thrust bearing.

Here, the thrust dynamic pressure generation groove 135 may be disposed at any position in the upper surface of the stopper plate 130. Generally, when the upper surface of the sleeve is provided with the thrust dynamic pressure groove, since the bypass channel communicates with the upper surface of the sleeve, such that a position at which the thrust dynamic pressure groove may be disposed may be restricted. However, in case of the hydrodynamic bearing assembly 100 according to the embodiment of the present invention, the stopper plate 130 is separately disposed on the upper surface of the sleeve and the bypass channel does not communicate with the upper surface of the stopper plate 130, such that a space in which the thrust dynamic pressure generation groove may be disposed may be widened. For example, the thrust dynamic pressure generation groove may be disposed in at least one of the upper surface of the stopper plate in the outer or inner diameter direction and the lower surface of the hub corresponding thereto.

The clearance between the stopper plate 130 and the hub 22 and the clearance between the sleeve 120 and the shaft 110 communicate with each other and the oil filling the respective clearances may be freely circulated. That is, an entirely connected bearing clearance may be formed, which is referred to as a full-fill structure.

The embodiment of the present invention illustrates that the thrust dynamic pressure generation groove 135 is disposed in the upper surface of the stopper plate 130 but the present invention is not limited thereto. The thrust dynamic pressure generation groove 135 may also be disposed in a lower surface of the disk portion 22a or both of the upper surface of the stopper plate 130 and the lower surface of the disk portion 22a.

In addition, the communicating portion 126 allowing the bypass channel 122 to communicate with the inner surface of the sleeve 120 in the inner diameter direction may be the second communicating groove 137 disposed in the lower surface of the stopper plate 130 in the axial direction and allowing the bypass channel 122 to communicate with the inner surface of the sleeve 120 in the inner diameter direction.

Further, the embodiment of the present invention describes, by way of example, the oil as the lubricating fluid, but the present invention is not limited thereto, and therefore another fluid capable of reducing friction between the rotating member and the fixed member at the time of the rotation of the rotating member while stably supporting the rotation of the rotating member may be used.

Meanwhile, according to the embodiment of the present invention, the thrust plate 130 may include the vertical portion 130b extending downwardly in the axial direction from the outer surface of the vertical portion 130b (in the outer diameter direction) to thereby be coupled to the outer surface of the sleeve 120 in the outer diameter direction. Therefore, the liquid-vapor interface may be disposed between the inner surface of the cylindrical wall portion 22b and the outer surface of the vertical surface 130b.

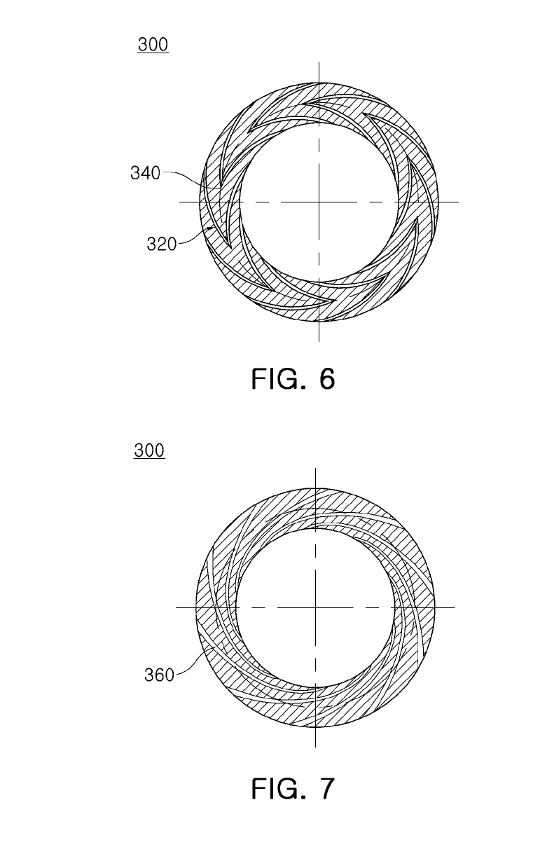

Hereinafter, a pumping groove 300 as the thrust dynamic pressure generation groove will be described with reference to FIGS. 6 and 7.

FIG. 6 is a pattern diagram of a herringbone groove of a thrust dynamic pressure bearing formed on the stopper plate according to an embodiment of the present invention and FIG. 7 is a pattern diagram of a spiral groove of a thrust dynamic pressure bearing formed on the stopper plate according to an embodiment of the present invention.

The pumping groove 300 having a herringbone shape of FIG. 6 is formed by continuously forming a herringbone groove 320 having a central bending portion 340 and the pumping groove 300 having a spiral shape of FIG. 7 is formed by continuously forming a spiral groove 360.

Describing the structure of the hydrodynamic bearing generated during the rotation of the motor including the hydrodynamic bearing assembly according to the embodiment of the present invention, the radial bearing is formed by the pressure generated due to the oil filling the micro clearance 125 between the outer circumferential surface of the shaft 110 and the inner circumferential surface of the sleeve 120 at the time of the rotation of the rotating member including the shaft 110 and the rotor 20, and the thrust bearing is formed by the pressure generated due to the oil filling the micro clearance between the upper surface of the stopper plate 130 and the lower surface of the hub 22, in particular, the lower surface of the disk portion 22a.

In this configuration, the oil between the outer circumferential surface of the sleeve 120 and the cylindrical wall portion 22b of the hub 22 is pumped through the thrust dynamic pressure generation groove 135 formed in at least one of the upper surface of the stopper plate 130 and the lower surface of the disk portion 22a, thereby forming the liquid-vapor interface (meniscus) 152.

Since the stopper plate 130 is fixed to the upper portion of the sleeve 120 in the axial direction, the micro clearance formed between the inner circumferential surface of the stopper plate 130 and the outer circumferential surface of the shaft 110 may be filled with the oil. Therefore, the thrust bearing may communicate with the radial bearing.

Meanwhile, the sleeve 120 or the bypass channel 122 formed to penetrate through the sleeve 120 in the axial direction and the stopper plate 130 may be filled with the oil, such that the oil filling the clearance between the lower surface of the sleeve 120 in the axial direction and the cover plate 140 may move into the bypass channel 122 by the pressure in the oil of the radial bearing.

In the hydrodynamic bearing assembly and the motor including the same according to the embodiments of the present invention, the rotating member may only include the shaft and the rotor to reduce the weight of the rotating member, such that impact resistance can be improved, low-current driving can be realized, the number of rotating components required in configuring the rotating member can be reduced, thereby reducing unbalance occurring in an assembling process of a rotating body and improving rotating precision.

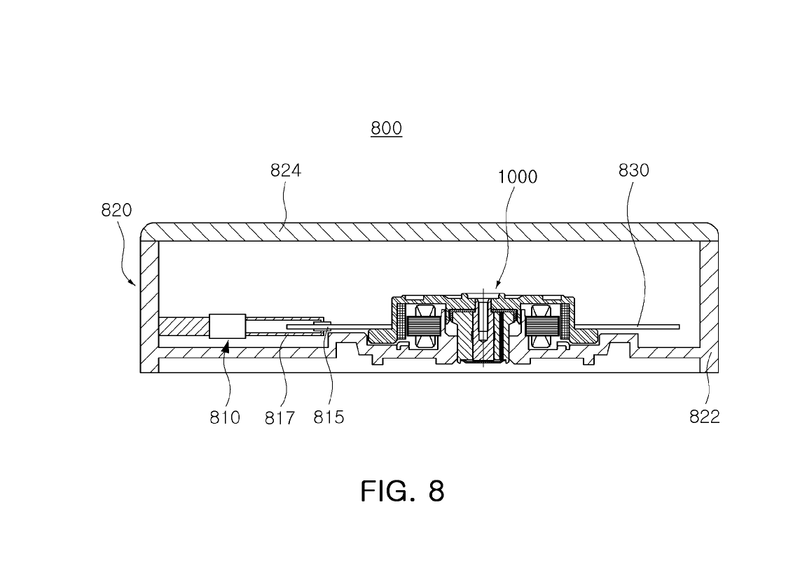

FIG. 8 is a cross-sectional view illustrating a recording disk driving apparatus equipped with motor according to the embodiment of the present invention.

Referring to FIG. 8, a recording disk driving apparatus 800 having the spindle motor 1000 mounted therein in accordance with the embodiment of the present invention is a hard disk driving apparatus and may include the spindle motor 1000, ahead transfer part 810, and a housing 820.

The spindle motor 1000 has all the features of the motor in accordance with the embodiment of the present invention and may have a recording disk 830 mounted thereon.

The head transfer part 810 may transfer a magnetic head 815 detecting information regarding the recording disk 830 mounted on the spindle motor 1000 to a surface of a recording disk to be read.

Here, the magnetic head 815 may be disposed on a support portion 817 of the head transfer part 810.

The housing 820 may include a motor mounting plate 822 and a top cover 824 shielding an upper portion of the motor mounting plate 822 so as to form an inner space in which the spindle motor 1000 and the head transfer part 810 are accommodated.

As set forth above, according to the embodiment of the present invention, the stopper plate can be provided to prevent the rotor and the shaft from overfloating and allow the thrust dynamic pressure bearing to be provided in an optically efficient position.

Further, according to the embodiment of the present invention, the stopper plate can be appropriately performed as the stopper by improving the coupling strength of the stopper plate coupled to the sleeve.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly, comprising:
a sleeve having a shaft inserted therein;
a rotor coupled to an upper portion of the shaft in an axial direction to rotate together with the shaft; and
a stopper plate including a horizontal portion coupled to an upper surface of the sleeve in the axial direction and a vertical portion extending downwardly in the axial direction from an outer surface of the horizontal portion to be fixed to an outer surface of the sleeve in an outer diameter direction, and preventing the shaft from floating at a time of rotation of the shaft.

2. The hydrodynamic bearing assembly of claim 1, wherein at least one of an upper surface of the stopper plate and a lower surface of the rotor corresponding to the upper surface of the stopper plate is provided with a dynamic pressure generation groove.

3. The hydrodynamic bearing assembly of claim 2, wherein the dynamic pressure generation groove is formed in at least one of the upper surface of the stopper plate in the outer diameter direction and the lower surface of the rotor corresponding thereto.

4. The hydrodynamic bearing assembly of claim 1, wherein a clearance is formed between an inner circumferential surface of the stopper plate and an outer circumferential surface of the shaft corresponding to the inner circumferential surface of the stopper plate.

5. The hydrodynamic bearing assembly of claim 1, wherein an inner diameter of the stopper plate is smaller than that of the sleeve.

6. The hydrodynamic bearing assembly of claim 5, wherein the shaft is provided with a stepped jaw portion caught by a lower inner surface of the stopper plate.

7. The hydrodynamic bearing assembly of claim 1, wherein the rotor is provided with a cylindrical wall portion extending downwardly in the axial direction, and
a liquid-vapor interface of a lubricating fluid is formed between an inner surface of the cylindrical wall portion and an outer surface of the vertical portion.

8. The hydrodynamic bearing assembly of claim 1, wherein the sleeve is provided with a bypass channel communicating with the upper surface and a lower surface of the sleeve in the axial direction, and
a communicating portion allowing the bypass channel to communicate with an inner surface of the sleeve in an inner diameter direction is disposed between the sleeve and the stopper plate.

9. The hydrodynamic bearing assembly of claim 8, wherein the communicating portion is a first communicating groove disposed in the upper surface of the sleeve in the axial direction and allowing the bypass channel to communicate with the inner surface of the sleeve in the inner diameter direction.

10. The hydrodynamic bearing assembly of claim 8, wherein the communicating portion is a second communicating groove disposed in a lower surface of the stopper plate in the axial direction and allowing the bypass channel to communicate with the inner surface of the sleeve in the inner diameter direction.

11. The hydrodynamic bearing assembly of claim 8, wherein the communicating part is a step spacing portion disposed on the upper surface of the sleeve in the axial direction and stepped downwardly in the axial direction from the bypass channel to an inner portion of the sleeve.

12. The hydrodynamic bearing assembly of claim 8, wherein at least one of an upper surface of the stopper plate and a lower surface of the rotor corresponding to the upper surface of the stopper plate is provided with a dynamic pressure generation groove.

13. The hydrodynamic bearing assembly of claim 1, wherein the stopper plate is provided to entirely cover the upper surface of the sleeve.

14. The hydrodynamic bearing assembly of claim 1, wherein the vertical portion is continuously provided in a circumferential direction.

15. The hydrodynamic bearing assembly of claim 1, wherein the vertical portion is press-fitted and coupled to the outer surface of the sleeve in the outer diameter direction.

16. The hydrodynamic bearing assembly of claim 1, wherein the vertical portion is bonded to the outer surface of the sleeve in the outer diameter direction by an adhesive.

17. The hydrodynamic bearing assembly of claim 1, wherein the stopper plate is manufactured by a sintering method.

18. A spindle motor, comprising:
a rotor including a hub having a hollow formed therein and having a shaft inserted therein and a magnet support portion extending in an outer diameter direction from the hub and bent downwardly in an axial direction to support a magnet;
a bearing member including a sleeve supporting a rotation of the shaft and a stopper plate including a horizontal portion coupled to an upper surface of the sleeve in the axial direction and a vertical portion extending downwardly in the axial direction from an outer surface of the horizontal portion to be fixed to an outer surface of the sleeve in the outer diameter direction and preventing the shaft from floating at a time of the rotation of the shaft; and
a stator including a core disposed outside of the sleeve and having a winding coil wound therearound to generate a rotational driving force by electromagnetic interaction with the magnet.
